(19) United States
(12) Patent Application Publication
(10) Pub. No.: US 2011/0246155 A1
(43) Pub. Date: Oct. 6, 2011

(54) Computer-Readable Medium And Systems For Applying Multiple Impact Factors

(76) Inventors: Aide Audra Fitch, Austin, TX (US); Robert Barry Howard, Dallas, TX (US)

(21) Appl. No.: 12/895,792

(22) Filed: Sep. 30, 2010

Related U.S. Application Data
(63) Continuation-in-part of application No. 12/750,223, filed on Mar. 30, 2010.

(51) Int. Cl. G06G 7/48

(52) U.S. Cl. 703/6; 700/291

(57) ABSTRACT

A system includes a processor and a memory. The memory includes a first data store configured to store a plurality of impact factors, each of which includes a normalized percentage change in an estimated building parameter attributable to a particular design choice associated with a proposed building. The memory further includes a plurality of instructions that, when executed by the processor, cause the processor to receive a first user input selecting at least one of the plurality of impact factors, bundle the at least one of the plurality of impact factors into a group in response to receiving the user input, receive a second user input including a name to associate with the group, and store the group and the name in the memory. At least one instruction, when executed by the processor, causes to the processor to apply the group to adjust a selected baseline model of a building to produce a resulting model.

### CROSS REFERENCE TO RELATED APPLICATION(S)

This application is a continuation-in-part of and claims priority from U.S. patent application Ser. No. 12/750,223 filed on Mar. 30, 2010 and entitled “Systems and Methods of Modeling Energy Consumption of Buildings,” which is incorporated herein by reference in its entirety.

### FIELD

The present disclosure is generally related to systems and methods of modeling energy consumption of buildings. More particularly, the present disclosure relates to systems and methods of applying multiple impact factors for modeling energy consumption of buildings based on user inputs.

### BACKGROUND

A number of computer programs are commercially available to estimate energy performance and/or cost performance of buildings. Such programs are known variously by terms such as energy modeling, simulation, building information modeling (BIM), construction cost calculators, energy assessment tools, life-cycle assessment tools, life-cycle cost calculators, and the like. With respect to energy modeling tools, such computer programs are designed to model energy consumption of a project with respect to one or more of the following factors: building layout (such as the orientation and placement of a building on a lot), material selection (such as the types of windows and other construction materials), system design (such as HVAC (heating, ventilating, and air-conditioning, security systems and other systems), plug and process loads (energy used for computers, audio-visual, manufacturing, and other non-building related uses), and equipment selection (such as the choice of equipment for implementing selected designs and systems).

In general, such computer programs can be used to assist in a decision-making process such that the finished project meets appropriate environmental goals while at the same time meeting a builder's desire for profitability. In some cases, energy simulation analyses are used to justify increased construction costs associated with “higher efficiency” equipment when such computer programs indicate that the life-cycle savings of such equipment provide an acceptable return on investment (ROI).

Unfortunately, modeling buildings with such software requires engineering time to configure the input data files, run the simulations, and analyze the output. Configuring the input data files can be complex and typically requires a significant amount of detail about the project. In some instances, such programs require three-dimensional CAD drawings as a starting point. However, at the point in the construction project when energy analysis computing systems can provide the most benefit, such as when the project is still at a conceptual stage and before drawings have been commissioned, many of the details may be unknown. Accordingly, to complete the modeling process at such a stage, the user estimates a large number of details. In such cases, the accuracy of the model generated by the modeling software is highly dependent on the knowledge of the person providing the estimates and the resulting life-cycle and cost models can have significant margins of error.

Additionally, the amount of time to model a building varies with the analysis software used, the complexity of the building, and the level of detail used in the model. Accurate modeling typically requires significant detail and setup time. However, since the engineering time to configure the data files and to model the project adds cost to a project, time spent on such modeling is often kept to a minimum. Unfortunately, less time spent during set up can also lead to further uncertainty in the resulting output models. If the configuration of the modeling software is short-changed, inaccuracy of the model is all but ensured, and the software's value to the decision-making process is reduced.

Thus, such modeling software is often not used at the point in the construction process where such information could provide the largest benefit, i.e., while the project is still at a conceptual stage and before architects have committed to a design. Conventional modeling systems typically require too much information to be reliably used when the construction project is still at a conceptual stage. If the user attempts to model a construction project based on his/her best guesses and such guess are inaccurate or incomplete, the modeling systems will produce cost-estimates having large uncertainty and potential omissions that can result in devastating and costly errors. Accordingly, such software is often used after design is completed and after significant planning costs have already been incurred.

### SUMMARY

In one embodiment, a system includes a processor and a memory. The memory includes a first data store configured to store a plurality of impact factors, each of which includes a normalized percentage change in an estimated building parameter attributable to a particular design choice associated with a proposed building. The memory further includes a plurality of instructions that, when executed by the processor, cause the processor to receive a first user input selecting at least one of the plurality of impact factors, bundle the at least one of the plurality of impact factors into a group in response to receiving the user input, receive a second user input including a name to associate with the group, and store the group and the name in the memory. At least one instruction, when executed by the processor, causes the processor to apply the group to adjust a selected baseline model of a building to produce a resulting model.

In another embodiment, a computer-readable storage medium includes a plurality of instructions that, when executed by a processor, cause the processor to receive a user input identifying a selection of a group of impact factors from a plurality of groups of impact factors. Each group includes multiple impact factors, and each efficiency factor includes a normalized percentage change in an estimated building parameter attributable to a particular design choice associated with a proposed building. Further, the instructions, when executed, cause the processor to adjust a baseline model of the proposed building based on the selection to produce an adjusted model of the proposed building and generate a user interface including data related to at least one of the baseline model and the adjusted model.

In another embodiment, a system includes an interface adapted to couple to a network and a memory to store a plurality of groups of impact factors of a plurality of impact factors. Each efficiency factor includes a normalized percentage change in an estimated building parameter attributable to a particular design choice associated with a proposed building. The system further includes a processor coupled to the memory and to the interface. The processor is configured to receive user input from the network and to selectively apply a group of the plurality of groups to a baseline model of a proposed building to produce an adjusted model in response to the user input. The processor is configured to generate a user interface including data from the adjusted model and to send the user interface to a destination device through the network.

### BRIEF DESCRIPTION OF THE DRAWINGS

FIG. 1 is a block diagram of an embodiment of a system to generate baseline energy usage factors, error margins, and impact factors for various buildings using one or more modeling tools.

FIG. 2 is a flow diagram of an embodiment of a method of generating percentage performance impact factors using, for example, the system of FIG. 1.

FIG. 3 is a flow diagram of an embodiment of a method of generating margins of error for each of the percentage performance impact factors using, for example, the system of FIG. 1.

FIG. 4 is a flow diagram of an embodiment of a method of generating weighted mean estimates based on percentage performance impact factors, error margins and baselines for various buildings using, for example, the system of FIG. 1.

FIG. 5 is a diagram of a representative example of multiple tables including a table of energy usage values for baseline building models and for the baseline building models including various energy impact factors produced using different modeling tools.

FIG. 6 is a block diagram of an embodiment of a system configured to model energy usage, construction costs, and operational costs for a building using baselines, impact factors, and associated margins of error.

FIG. 7 is a block diagram of an expanded view of the modeling system of FIG. 6 and including an expanded view of the data sources.

FIG. 8 is a block diagram of a second embodiment of a modeling system configured to model energy usage, construction costs, and operational costs for a physical structure.

FIG. 9 is a flow diagram of a second embodiment of a method of modeling energy usage, construction costs, and operational costs for a physical structure using, for example, the system of FIG. 8.

FIG. 10 is a diagram of an embodiment of a user interface produced by the modeling systems of FIGS. 6-8 to receive user input related to a physical structure and to provide reports related to the modeled energy usage, construction costs, and operational costs for the physical structure.

FIG. 11 is a block diagram of an embodiment of a system including the computing system of FIG. 1 having further process-executable instructions for creating groups or bundles representing multi-impact factors.

FIG. 12 is a simplified block diagram of a second embodiment of a system for creating customized impact factors.

FIG. 13 is a diagram of an example of a table depicting an example of a static summary of quantified differences between baseline building models and proposed models.

FIG. 14 is a diagram of a second embodiment of a user interface including a dashboard of indicators depicting a summary of quantified differences between a proposed model relative to a baseline model.

In the following description, the use of the same reference numerals in different drawings indicates similar or identical items.

### DETAILED DESCRIPTION OF ILLUSTRATIVE EMBODIMENTS

Embodiments of a system are described below for modeling energy usage and costs for proposed buildings based on user inputs, such as building usage type, square footage, and geographic location or zone, which provide less than a complete characterization of the proposed building. A robust database of unitized energy baselines (energy use per square foot) is derived through modeling and/or compiling real building data for buildings of different shapes, sizes, uses, and locations. The modeling system is configured to utilize the database to determine annual energy usages for each building model and by dividing the annual energy usage by a square footage of the building model. The system is configured to select a unitized baseline and to multiply the unitized baseline by a square footage from the user input to produce substantially instantaneous baseline modeling results, including baseline environmental and economic impact models.

Further, the system allows the user to add additional details, as desired, to see how changes can alter the environmental impact and the cost impact of the building and/or to refine the profile of the building to improve the accuracy of the model. The system selects one or more impact factors from a plurality of impact factors based on the additional details, multiplies the one or more impact factors by the square footage, and adjusts the baseline environmental and economic impact models based on the product to produce adjusted environmental and economic impact models for the building. The term “efficiency factor” refers to a percentage change in energy consumption attributable to a particular energy efficiency strategy or design choice associated with a proposed building, which percentage change is normalized over the square footage. The term “impact factor” refers to a normalized change, such as a normalized percentage change relative to a baseline or other type of value that is normalized to some easily quantifiable attribute of a building or design (such as the square footage), that might impact energy consumption, costs, return on investment, cash flow, environmental impacts, or other parameters of a proposed building based on the user's design choices for a proposed building. In some instances, the impact factor may also be adjusted based on a geographic region or another factor that would cause differences between such impact factors. In some instances, the impact factor is a numerical quantity or an algorithm with some multiplier. For example, a construction cost premium for increasing roof insulation could be an impact factor that includes an additive adjustment of +$1.50 per square foot of roof area.

In some instances, the system provides a user interface that includes results from baseline and adjusted models, allowing a user to view them side-by-side. Visual indicators provide readily understandable information about a particular model relative to the baseline model. Additionally, the modeling system provides margins of error relative to the various environmental and cost impact models, so that the user can incorporate such error margins into the planning process.

As discussed below in greater detail, the modeling system is configured to utilize pre-configured, unitized baseline factors and a plurality of impact factors (representing percentage performance efficiency, energy-usage reduction factors) to provide environmental impact models based on limited information from a user and based on each additional piece of information provided by the user. The plurality of impact factors are produced by modeling building profiles with selected environmental strategies using one or more software modeling tools and by determining a percentage contribution attributable to each of the selected environmental strategies and by normalizing the percentage contribution over a square footage of the building profile to produce a unitized efficiency factor for each energy efficiency strategy.

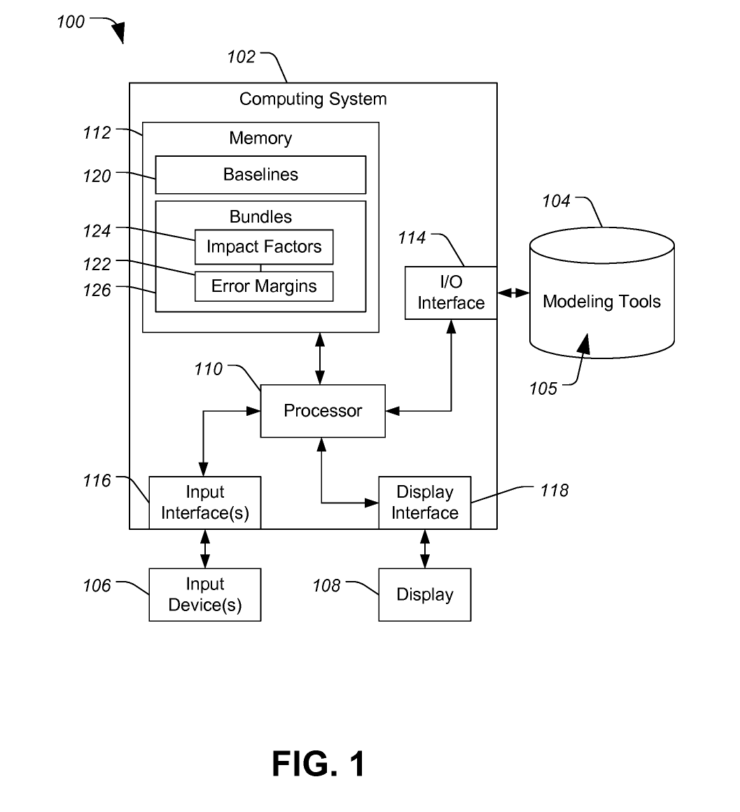

FIG. 1 is a block diagram of an embodiment of a system 100 to generate impact factors 120, error margins 122, and baselines 124 for various building models using one or more modeling tools, such as modeling tools 105 stored in a database (or memory) 104. Further, system 100 is configured to bundle groups of impact factors 120, which can be selected by an operator to represent a single multiple-impact selection. The bundled groups can be stored in a bundles data source 126. For example, within one bundle of the bundles data source 126, multiple impact factors 120 (including impact factors even those in different categories, such as a first efficiency factor associated with water consumption and a second efficiency factor associated with carbon dioxide emissions, as well as other impact factors such as construction cost increases, green rating contributions, and embodied CO₂ quantities) can be bundled together to represent the multiple efficiencies and effects (impacts) of a single selection. The generation and use of data from bundles data source 126 are explained in greater detail below. Further, such impact factors 120 may be stored together with associated error margins 122.

System 100 includes a computing system 102, which is communicatively coupled to a data source 104, which can be a single-entity data source or a distributed data source that is distributed across multiple servers. In other instances, data source 104 can be included within memory 112.

Computing system 102 can be a personal computer, multiple servers interconnected to process large amounts of data, or a portable computing device having sufficient processing power and memory capacity to model energy usage of a building. Computing system 102 includes one or more input interfaces 116 connected to one or more input devices 106 (such as a keyboard, a mouse, a scanner, and the like) to receive user input and a display interface 118 connected to a display 108 (such as a liquid crystal display (LCD), a monitor, another type of display, and the like) to display information. The one or more input interfaces 116 may include a wireless transceiver (such as a Bluetooth®-enabled transceiver) configured to receive user input through a wireless communication channel and/or a wired or wireless connection to a wide area network, such as the Internet. Computing system 102 also includes a processor 110 and a memory 112 accessible to processor 110. Further, computing system 102 includes an input/output (I/O) interface 114 that is configured to communicate with the data source 104. Memory 112 is a computer-readable storage medium embodying data and instructions executable by processor

In an example, a user selects modeling tools for modeling a building profile. Alternatively, memory 112 includes instructions executable by the processor 110 to iteratively select modeling tools, adjust parameters, and model energy usage for various building profiles. The user supplies data related to a physical profile of the building using one or more input devices 106 and applies the selected one of modeling tools 105 to the building to produce a baseline energy usage value. The baseline energy usage value is then divided by a square footage of the building to produce a unitized baseline factor for the building. The process is repeated for different building sizes and types using the same modeling tool and then using other modeling tools. Thus, a plurality of unitized baseline factors are produced and stored in memory 112 as baselines 124.

In one particular example, baseline building models are produced using building standards promulgated by the American Society of Heating, Refrigerating and Air-Conditioning Engineers (ASHRAE), including the building code standards commonly referred to as ASHRAE 90.1-2007, to define the characteristics of a baseline building model, including amount of insulation, efficiency of equipment, etc. Computing system 102 calculates the energy performance of this baseline model using a selected one of the plurality of modeling tools 105, such as the DOE-2 energy usage modeling tool, to produce a total annual energy usage value for the baseline model building, which total annual energy usage value is divided by the square footage of the model building to yield the unitized baseline or standard unitized baseline, which may be expressed in kilowatt hours per year per square foot (kWh/yr/SF). Memory 112 stores the unitized baseline together with building type, and in some instances location data, as baselines 124. Subsequently, the system 100 can use a correct unitized baseline from baselines 124 for a type of building specified by a user and multiply it by the square footage of the user's building (kWh/yr/SF×SF) to yield a total estimated energy usage (kWh/yr) for the user's building.

Further, an array of energy efficiency strategies are applied to each of the baseline models, one at a time (and some in combination). Computing system 102 calculates the new energy usage for the adjusted building model using a selected one of the plurality of modeling tools 105, such as the DOE-2 modeling tool. Computing system 102 determines the margin of improvement attributable to the applied energy efficiency strategy ((Baseline usage−improved usage)/baseline usage) to yield a percentage factor referred to as the efficiency factor and stores the data in memory 112 as impact factors 120.

It is understood that each modeling tool 105 applied to model a particular building and/or energy efficiency strategy produces a different energy usage value. Accordingly, computing system 102 can compare the resulting energy usage values for a given building profile to determine a margin of error for each of the building profiles and for each energy efficiency strategy. Computing system 102 stores the results are stored in memory 112 as margins of error 122.

Further, the process may be repeated using different geographic locations, producing geographically specific baselines, impact factors, and associated error margins. Further, in some instances, actual buildings and real energy usage data can be used to improve the accuracy of the baselines and the impact factors by modeling the actual building using the baseline and impact factors to produce a set of theoretical results and comparing the set of theoretical results to actual data. Error margins can be adjusted for each of the modeling tools 105 and for each of the baselines 124 and impact factors 120 by comparing the predicted values to actual energy usage data collected from existing structures from which some of the building profiles are derived.

In some instances, a particular selection option implicates multiple result categories, such as energy usage, construction costs, etc. Many building decisions involve analysis of multiple potential selection options, each of which potentially impacts different aspects of the decision. In a building design example, upgrading the thermal insulation of a building reduces energy usage, but also adds to the cost to install. Thus, an “upgrade thermal insulation” bundle of the bundles data source 126 includes an energy-related efficiency factor and a construction cost-related impact factor of impact factors 120. The energy-related efficiency factor would create an impact in an energy category that can be quantified, for example, in kilowatt-hours per year or another measure of energy usage. The construction cost-related impact factor would create an impact in the construction cost impact category, quantified in dollars or another unit of monetary exchange.

Often, when a decision involves implementing several multi-impact actions, each impact can compound effects on the same impact category, and the results can become complex and difficult to model. Some such multi-impact actions aggregate in each respective category. However, in some instances, the impact factors are non-additive. System 100 utilizes the bundles data source 126 to quantify multi-impact decisions to allow the system to work even where there are several different impact categories that cannot be easily combined or even ranked against one another. By combining multiple impacts in a model, such non-additive results can be identified and reduced to a normalized, quantized value that can be re-used when a decision implicates such impacts.

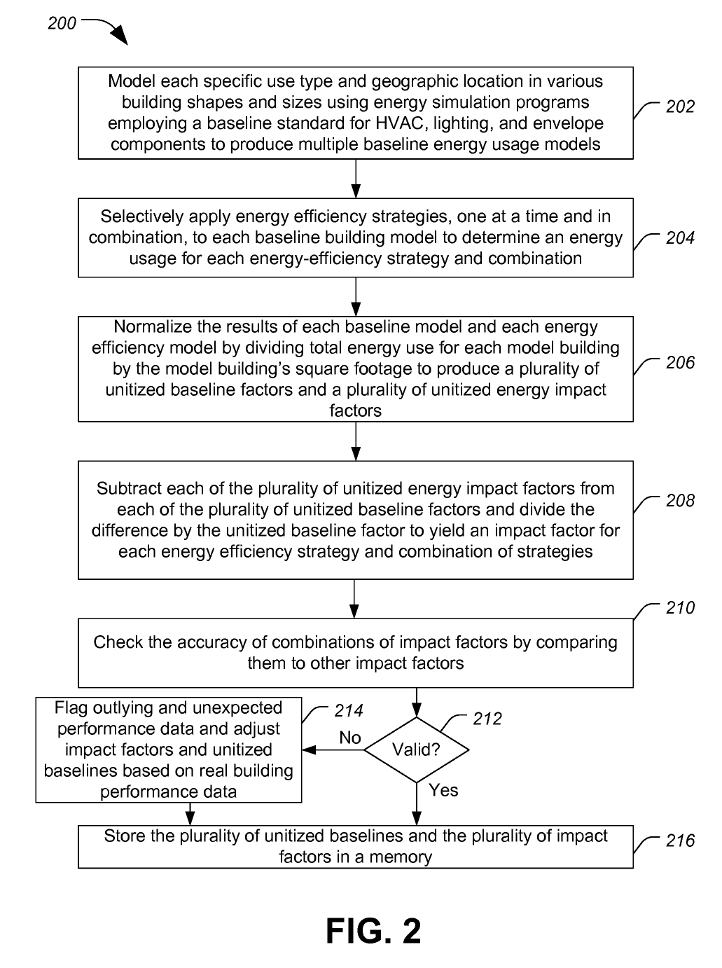

The modeling of each of the buildings using computing system 102 sometimes includes providing computer-aided architectural diagrams (CAD) drawings to computing system 102 using one of the input devices 106, such as a scanner. Further, the modeling tools in data source 104 includes a variety of conventional modeling tools, such as the Department of Energy's environmental impact modeling tool (DOE-2 or DOE-II), a newer version, such as the Department of Energy's Energy Plus energy modeling tool, and other tools, which provide reliable environmental impact models. Such tools estimate energy usage, carbon footprint, utility usage (energy, water, etc.), land usage, and other environmental parameters. However, such tools require significant data inputs to provide reliable models. By applying the modeling tools to a variety of buildings, building usage types, envelope materials, systems, and material selections, multiple models are created and the various models are then normalized and processed to produce unitized values stored as baselines 124 and impact factors 120. An example of one method of creating baselines 124 and impact factors 120 is discussed below with respect to FIGS. 2-4.

FIG. 2 is a flow diagram of an embodiment of a method 200 of generating impact factors. At 202, each specific use type and geographic location for a building are modeled in various building shapes and sizes using existing energy simulation programs (and/or cost modeling programs) employing baseline building standards for HVAC, lighting, systems and envelope components (such as ASHRAE 90.1-2007 building standards) to produce multiple baseline energy usage models. Each baseline energy usage model represents an energy efficiency model of a building that satisfies current building codes for the selected geographic region. The specific use type represents the use intended for the building, such as “office,” “restaurant,” “retail,” “multifamily residential,” “industrial,” “single family residential,” or some combination of thereof, which use type has different baseline parameters, which may be defined by building codes or standards for such building types. Further, the geographic region is taken into account, since environmental performance can vary based on the environment in which the building is to be constructed.

Advancing to 204, energy efficiency strategies are selectively applied, one at a time and in combination, to each baseline building model to determine an energy usage for each energy-efficiency strategy and combination. For example, selecting a particular type of roof-insulation, a particular type of envelope material, particular types of windows, percentage of windows, water reclamation strategies, and other variations can impact the energy-efficiency model of the building.

Continuing to 206, the results of each baseline model and each energy efficiency model are normalized by dividing total energy usage for each model building by the model building's square footage to produce a plurality of unitized baseline factors and a plurality of unitized energy impact factors. By normalizing the results over the square footage, the energy efficiency model can be simplified to a numeric value (a unitized value), which can be used to estimate an environmental impact for other buildings based on square footage information.

Continuing to 208, each of the plurality of unitized energy impact factors are subtracted from each of the plurality of unitized baseline factors, and the difference is divided by the unitized baseline factor to yield an efficiency factor for each energy efficiency strategy and combination of strategies. In an example, each efficiency factor represents a percentage performance efficiency gain attributable to one or more of the energy efficiency strategies.

Moving to 210, the accuracies of combinations of the impact factors are checked (verified) by comparing them to other impact factors. In particular, deviations (such as outlying or unexpected results) are analyzed to determine if the results are valid If the difference or deviation exceeds a threshold, the margin of error of a given efficiency factor for an individual energy strategy may be outside of an acceptable margin of error.

At 212, if the efficiency factor or a baseline is outside of an acceptable margin of error (i.e., is not valid), the method advances to 214 and outlying and unexpected performance data are flagged and the efficiency factor or baseline for the individual efficiency strategy is adjusted based on real building performance data. In some instances, the impact factors and/or the baselines can be manually adjusted. Alternatively, the individual efficiency factor can be replaced or the modeling can be performed again to correct for results that are anomalous. Once adjusted (at 214) or if the efficiency factor is within the margin of error (at 212), the method proceeds to 216 and the plurality of unitized baselines and the plurality of impact factors are stored in a memory.

In some instances, the different unitized baselines for a given building produced using different modeling tools are averaged to produce an average unitized baseline for a given building type in a given location or geographic zone. The average unitized baseline data can be calibrated with real project case studies to produce the margins of error, providing a true representation of accuracy and greater predictability than standard thermal transfer analyses, because the real case study data statistically accounts for non-idealized, unpredictable real-world effects, such as poor construction, erratic occupant usage, and inconsistent maintenance.

In the above-described system, different modeling software are separately applied to each building model and to each combination of energy efficiency strategies for different building types and sizes to produce a plurality of unitized baselines and a plurality of impact factors for each of the multiple modeling tools. The method 200 may be performed iteratively, processing each building profile and its variations using each available modeling tool.

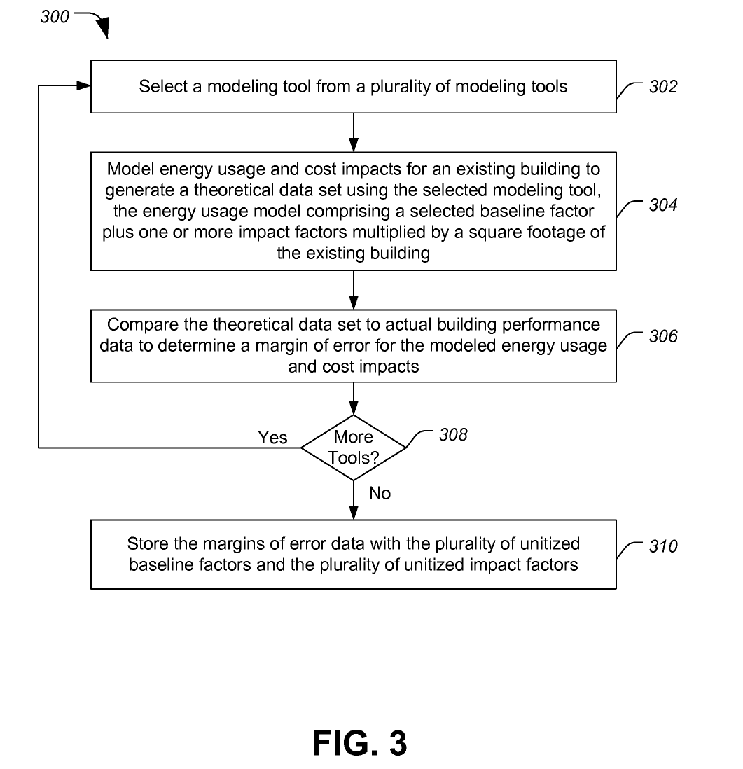

As previously mentioned, the resulting energy usage models include some margin of error, whether or not the modeling tool recognizes the possibility of such an error. Since the plurality of unitized baselines and the plurality of impact factors include the possibility of such error margins, it is desirable to include reliability estimate or error margin data. Accordingly, a method of determining a margin of error for a given unitized baseline and one or more impact factors using real building case studies is described below with respect to FIG. 3.

FIG. 3 is a flow diagram of an embodiment of a method 300 of generating margins of error for each of the percentage impact factors. At 302, a modeling tool is selected from a plurality of modeling tools (such as the modeling tools stored in data source 104 depicted in FIG. 1). Advancing to 304, energy usage and cost impacts are modeled for an existing building to generate a theoretical data set using the selected modeling tool, using a selected baseline factor plus one or more impact factors multiplied by a square footage of the existing building. In particular, a user accesses a user interface to enter building information, including square footage, location, building type, and other information, such as one or more energy efficiency strategies associated with the building.

Continuing to 306, the theoretical data set is compared to actual building performance data to determine a margin of error for the modeled energy usage and cost impacts. In particular, real building case studies are modeled using the baselines and impact factors to generate the theoretical data sets, which are then compared to the actual building performance data to determine a margin of error for the simulation tool. If the margin of error is too large, the data is examined to adjust the selected baseline and/or the one or more impact factors. Additionally, if the margin of error is too large, the input data is examined for errors and/or omissions.

The process is repeated utilizing more than one existing energy simulation tool or method. In particular, moving to 308, if there are more simulation tools or methods, the method returns to 302 and another modeling tool is selected from the plurality of modeling tools. Otherwise, the method proceeds to 310 and the margins of error data are stored with the plurality of unitized baseline factors and the plurality of unitized impact factors in memory. In an embodiment, the margins of error are stored with their corresponding baselines and impact factors.

It should be understood that the margins of error are related to the tools at this stage. However, the margins of error should be correlated to the normalized baselines and the impact factors so that they can be readily applied to estimate environmental and cost impacts for other buildings. In one embodiment, the baselines, the impact factors, and the margins of error are reviewed by a professional engineer. For each data point, the engineer produces a mean or professional “best-guess” substitute value, which is derived from real case studies of building performance. In another embodiment, the baselines, impact factors, and margins of error are averaged to produce average baseline, average efficiency factor, and average error margin data. Such error margins may be stored with impact factors and compiled and reported in the data output provided to a user, providing a mechanism for reporting impacts based on user selections and allowing the user to view the impacts from certain building decisions. This allows the user to make more informed decisions based on the level of risk they associate with the reported margins of error.

In one example, performance data from real building case studies can be collected and added to the tabulated data sets to weight the mean toward real-life performance. In this instance, the real performance data is used to train or enhance the impact factors and baselines, improving the accuracy of the predicted environmental and cost impact reports.

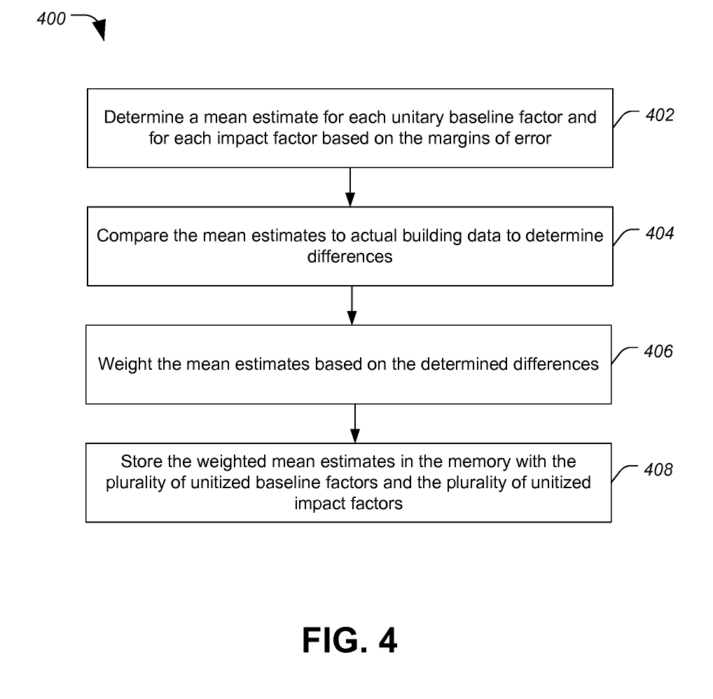

It is possible to generate such mean or best-guess substitute values automatically using a computing system, such as computing system 102 depicted in FIG. 1. In some instances, the computing system 102 includes instructions executable by processor 110 to analyze the tabulated data points and to weight the data points based on real performance data. An example of a method that can be implemented on the computing system 102 is depicted in FIG. 4.

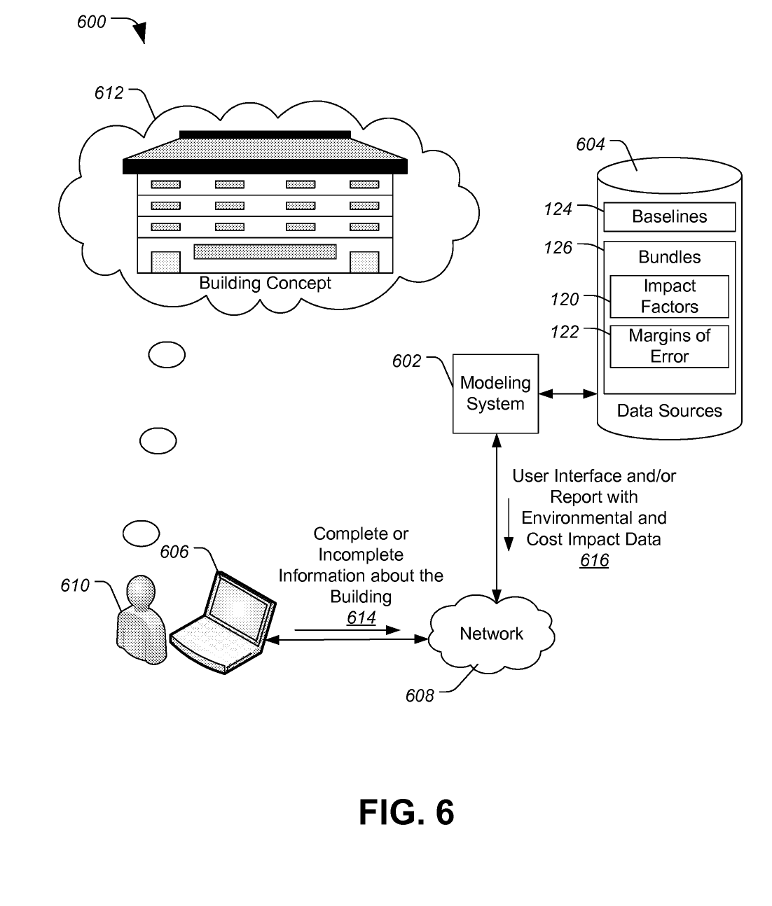

FIG. 4 is a flow diagram of an embodiment of a method 400 of generating weighted mean estimates based on percentage performance impact factors, error margins and baselines for various buildings. At 402, a mean estimate for each baseline and for each efficiency factor is determined based on the margins of error. Continuing to 404, the mean estimates are compared to actual building data to determine differences. Advancing to 406, the mean estimates are weighted based on the determined differences. Moving to 408, the weighted mean estimates are stored in the memory the plurality of unitized baseline factors and the plurality of unitized impact factors, which can be used by a computing system, such as computing system 102 depicted in FIG. 1 or computing system 602 depicted in FIG. 6, to model environmental and cost impacts of a building based on limited input data received from a user. FIGS. 6-10 illustrate aspects of a system to model such environmental and cost impacts of a building using the pre-configured baselines, the impact factors, and the associated margins of error.

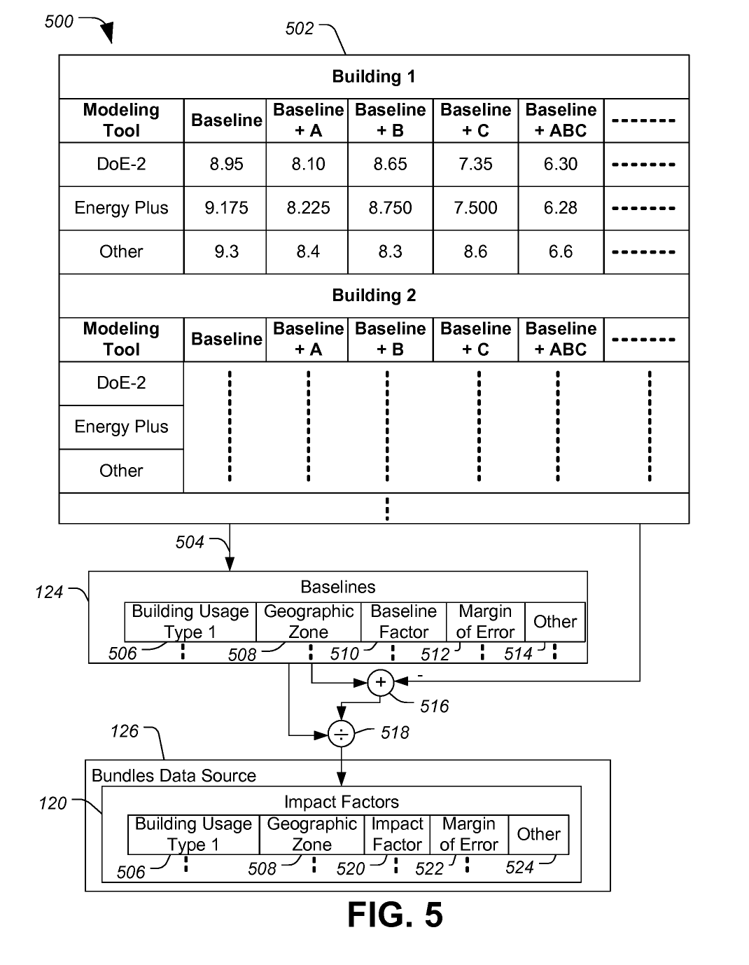

FIG. 5 is a diagram of a representative example of multiple tables 500 including a table of energy usage values for baseline building models and for the baseline building models including various energy impact factors produced using different modeling tools. Tables 500 include a table 502 of energy usage, baselines 124 and impact factors 120. Table 502 includes unitized baseline energy usage values and unitized energy usage values for the baseline model plus one or more energy efficiency strategies, which values are normalized by square footage values. Each baseline building model (Building 1, Building 2, etc.) is modeled using multiple modeling tools, such as the Department of Energy (DOE) energy modeling tool DOE-2, Energy Plus, or other energy modeling tools.

Each building model represents a complete building profile that satisfies the building codes for a particular geographic region to produce a baseline energy usage value. The building model is created using one or more industry standards, such as the ASHRAE 90.1-2007 standard. The energy usage value is divided by the square footage of the building model to produce a performance energy factor having units of kWh/yr/SF. In this example, the unitized baseline factor for Building 1 determined using the DOE-2 modeling tool is 8.95 kWh/yr/SF.

Various energy efficiency strategies (A, B, and C) are added individually and in various combinations, such as A+B, A+C, B+C, A+B+C, etc, and each of the modeling tools are applied again to determine an energy usage factor for each of the building models. For example, energy efficiency strategy A can include R-31 roofing insulation or a radiant barrier, as compared to R-19 insulation required by the building code for the particular region. Energy efficiency strategy B could be instantaneous (or tankless) water heaters, as compared to traditional gas or electric water heaters as required by the building code for the particular region, and so on. Any number of energy efficiency strategies can be modeled alone and in combination to produce energy usage values, which can be divided by the square footage to produce a plurality of energy usage factors.

Once the unitized baselines and the unitized energy usage values are calculated, the unitized baselines and impact factors can be determined. In an example, the unitized baselines determined for a particular building using different modeling tools are averaged to produce an average unitized baseline. Alternatively, one of the multiple unitized baselines can be selected based on its relative accuracy when compared to real data. In general, the determination process is indicated at 504, and the resulting unitized baseline for a given building model in a particular location is then stored in memory as baselines 124.

The baselines 124 include an associated building usage type 506, such as residential, retail, office space, etc. Further, baselines 124 include a geographic zone 508, the baseline factor 510, an associated margin of error 512, and optionally other data. Such other data includes update information, such as when the particular baseline factor was last verified or last adjusted based on real building data.

Further, impact factors can be determined for each energy efficiency strategy by subtracting each energy usage factor for each of the energy efficiency strategies from the baseline factor 510 at 516 to produce a difference. The difference is then divided by the baseline factor at 518 to produce an efficiency factor, which is a percentage energy efficiency improvement that is attributable to the particular energy efficiency strategy or combination of strategies. For example, the efficiency factor for the Baseline plus an energy efficiency factor (A) building model associated with the Building 1 model using the DoE-II tool would be calculated as follows:

$$Energy {Efficiency}_{A} = \frac{8.95 - 8.10}{8.95} = 0.09497 = 9.497 \% \qquad ( Equation 1 )$$

Alternatively, if the baseline factor is averaged, the average baseline value may be 9.14 and the average Baseline plus the energy efficiency factor (A) building model value may be 8.24. In this instance, with these values applied using Equation 1 produces an efficiency factor_{A} value of approximately 0.09846 or approximately 9.8%.

The resulting efficiency factor is stored as impact factors 120. In the illustrated embodiment, impact factors 120 include building usage type 506, geographic zone 508, an efficiency factor 520, an associated margin of error, and optionally other data 524. In an example, the other data 524 can include update information indicating the last time the efficiency factor 520 was modified.

In some instances, multiple factors of impact factors 120 can be bundled together into a group to form a bundle, which can be stored within bundles data store 126. A bundle represents a single, multi-impact decision or action, such as “upgrade thermal insulation,” “upgrade facade from siding to brick,” and so on. Such single decisions can impact one or more impact factors, alter costs, and affect long-term operating costs and estimated energy consumption. In general, each impact factor of a selected bundle within bundles data store 126 relates to a different impact category (such as energy usage, carbon dioxide footprint, construction costs, operating costs, etc.).

It should be understood that the numbers depicted in table 502 and used in Equation 1 are fictitious numbers provided for illustrative purposes only. Further, while only three modeling tools (DoE-2, Energy Plus, and Other) are depicted in table 502, it should be understood that any number of modeling tools can be used to refine the baselines and/or impact factors. Additionally, while a mean or average of baselines and impact factors are discussed above, certain modeling tools have a lower margin of error relative to other modeling tools (as compared to real data), and their corresponding performance impact factors can be weighted more than those from the other modeling tools to determine the baselines 124 and impact factors 120. For example, if Energy Plus has a lower margin of error in its energy usage calculations as compared to DoE-2 and other modeling tools, the Energy Plus is weighted more heavily than the results from the modeling tools to produce baselines 124 and impact factors 120.

Further, while table 502 depicts only two buildings, it should be understood that a variety of buildings having different usage types (residential, commercial, retail, industrial, or some combination thereof), different square footages, and different geographic locations can be modeled to produce a wide range of unitized baselines and unitized impact factors, which can be applied to model new buildings based on the usage type and geographic region information, as discussed below with respect to FIGS. 6-9.

FIG. 6 is a block diagram of an embodiment of a system 600 configured to model energy usage, construction costs, and operational costs for a building using baselines 124, impact factors 120, and associated margins of error 122. System 600 includes a modeling system 602 that is communicatively coupled to one or more data sources 604, including pre-configured mean energy usage information, baselines 124, impact factors 120, margins of error 122, and bundles data store 126. Additionally, modeling system 602 is communicatively coupled to one or more user devices, such as user device 606 through a network 608, such as the Internet. User device 606 may be a portable computer, a personal digital assistant (PDA), a phone, or other electronic device having a processor and having access to network 608.

In operation, a user 610 with a building concept 612 accesses a user interface associated with modeling system 602 through network 608 via user device 606. Modeling system 602 provides a user interface to user device 606. In an example, the user interface may be rendered within an Internet browser application and displayed on a display of user device 606. User 610 interacts with the user interface through an input interface, such as a keyboard, track pad, or mouse of user device 606 to provide information 614 about the building, which information 614 is sent to modeling system 602 through network 608. Information 614 can be a complete or incomplete building profile for the building concept 612. In some instances, information 614 can include digital images such as computer-aided design images. In other instances, information 614 includes only square footage, building usage type, and geographic zone (location) information.

Modeling system 602 is adapted to access the pre-modeled performance data (such as baselines 124, impact factors 120, margins of error 122, and other data) stored in the one or more data sources 604, to select the data set from the one or more data sources 604 that most closely resembles the building concept 612 defined by information 614, and to estimate environmental and cost impacts by multiplying by the input square footage by the selected data set. As will be discussed in greater detail below, the impacts are calculated using the selected one of baselines 124 and one or more of the impact factors 120 that most closely resemble information 614. Once calculated, modeling system 602 generates a user interface and/or a report 616 with predicted environmental and cost impact data for the building concept. The user interface and/or report 616 can be provided to user device 606 through network 608.

User 610 can interact with the user interface presented on user device 606 to modify the user inputs and further to define the building information, which causes the report information to change in real time or near real time. In some instances, the adjustments may be performed using embedded scripts within the user interface. In other instances, the user device 606 may communicate changes to modeling system 602 and receive updated information from modeling system 602 to update the environmental and cost impact data shown within the user interface on user device 606. In a particular example, some possible efficiency factors (such as commonly selected options) for a particular building type and location can be embedded within an eXtensible Markup Language (XML) file sent to the user's device for rendering, for example, within an Internet browser application. In this instance, the user's browser generates the user interface or report 616 using information from the XML file. Where the XML file includes algorithms or scripts, the user's Internet browser application may apply or execute such scripts so that user inputs can be processed substantially instantaneously within the user's Internet browser application to provide updated environmental and cost impact data. In some examples, all processing may be performed by one or more servers and the results may be sent to the user's device. In still other examples, processing may be distributed such that some processing (including interface rendering) is performed on the user's device while other processing (including data retrieval) is performed by a server with which the user's device is communicating.

In a particular example, the user 610 provides a geographic location, building usage type, and square footage to modeling system 602. Modeling system 602 selects a baseline factor that is closest to the user input (based on the building type and location) and calculates environmental and cost impacts by applying the selected baseline to the square footage provided by the user. As the user 610 makes subsequent changes, modeling system 602 applies selected impacts from data sources 604 (or access imbedded impact factors) to update the environmental and cost impacts. In one instance, the impact factors are applied to the existing baseline model to adjust the environmental and cost impacts relative to the existing baseline.

In an example, when the user 610 makes a subsequent change that implicates multiple impact factors that are grouped within a bundle of bundles data store 126, modeling system 602 identifies the bundle and applies the bundle to the user input to model the various impacts of the particular decision. In one instance, modeling system 602 selects the bundle automatically based on the user's input. In another instance, modeling system 602 provides a graphical user interface including a user-selectable menu (or other selection indicator) accessible by the user to adjust the environmental and cost impacts relative to the existing baseline or the previously adjusted model.

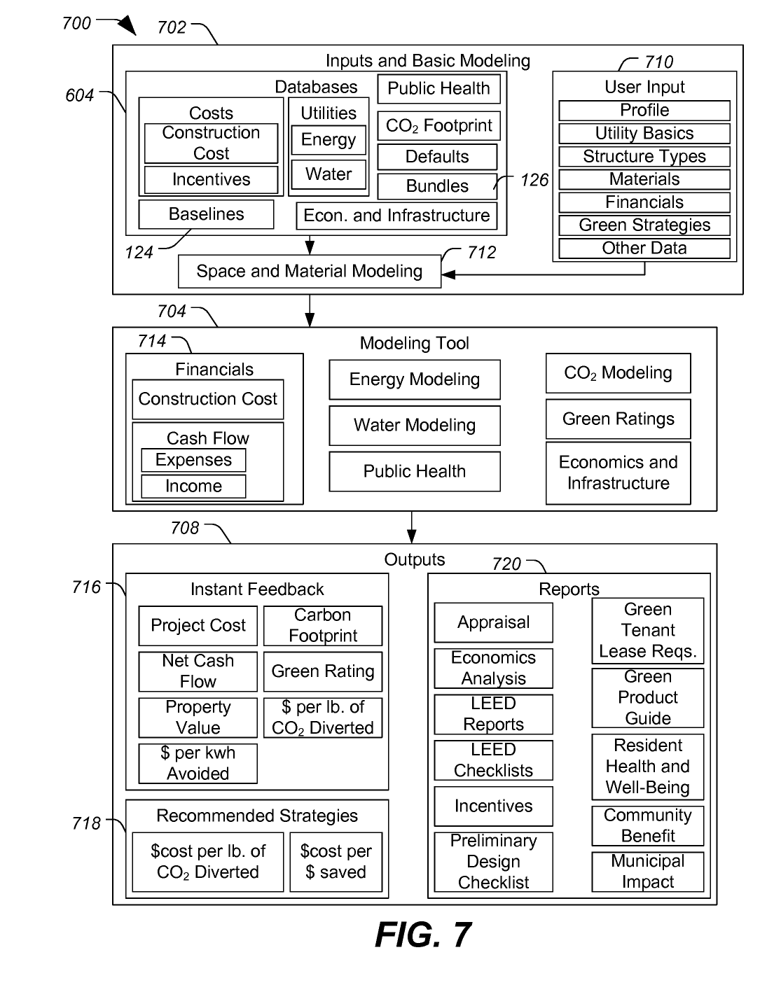

FIG. 7 is a block diagram of a second embodiment of a modeling system 700 configured to model energy usage, construction costs, and operational costs for a physical structure. System 700 includes an inputs and basic modeling component 702, which is coupled to a modeling tool 704, which is coupled to an output component 708.

Inputs and basic modeling component 702 includes data sources 604, a user input module 710, and a space and material modeling system 712. Data sources 604 include costs data, including construction costs and incentives. The construction costs include the construction cost of each major building component and environmental strategy or option (“green” option), which costs are collected and updated on a regular basis through various sources. Such sources can include industry standard cost references, consultants, partners in the construction industry, real building case studies, and other sources. Further, such construction cost data also includes data collected through voluntary cost data provided by customers or others in the construction or building management industries. Within data sources 604, the cost information can be normalized relative to a national average. Later, during modeling, a user-input corresponding to a numerical addition multiplied by a building specific multiplier is applied by space and material modeling 712 to adjust costs for regional or market conditions. Since default cost data is updated regularly, the costs data can be used to provide an easily accessible cost estimating tool for users of the system 700.

Costs data further includes incentives data, which can include a compilation of tax credits, tax deductions, grants, rebates, and other financial benefits or incentives provided by various governmental and non-governmental entities for environmental (or “green”) strategies, revitalization efforts, and other opportunities. Incentives are organized by federal, state, and city-specific offerings and include data related to qualifying entities. Provided the user of the system qualifies for a possible incentive, the incentive is automatically incorporated in cost calculations whenever relevant green strategies, location, and other parameters are triggered. Incentives data are updated regularly to offer customers an easy, one-stop clearinghouse for green incentives, and may be used by modeling tool 704 to recommend particular strategies.

Data sources 604 also include utility data, including energy data and water data. The energy data can include pricing rates for electricity and/or gas in various user locations. Further, the energy data can include baseline energy usage for typical fixtures and building usage types.

The water data includes a compilation of baseline water use for typical fixtures and equipment, as well as reduced water use for low-water (“green”) fixtures and equipment. Further, water data includes information related to the water collection potential for rainwater and grey water collection systems. Pricing rates for water and wastewater in various user locations are also provided. Water use and conservation potential is calculated in various ways. Such energy and water data is updated regularly based on available information.

For building plumbing fixtures, a default number or user-provided number of occupants for each space is multiplied by baseline usage and fixture flush, flow, or cycle rates. For landscape irrigation, landscape area data are multiplied by typical water use per square foot. Water use is then multiplied by utility water and wastewater cost rates for each space. If a green strategy for plumbing is selected, then reduced flush, flow, or cycle rates are used. If a green strategy for landscape is selected, a corresponding reduced irrigation rate is used.

Data sources 604 further include public health data including estimates of pollutants resulting from the construction and operation of the building and corresponding public and occupant health impacts. Such data is derived from Life-Cycle Assessment modeling, other pollutant and health impact estimating techniques, and academic studies.

Data sources 604 also include carbon dioxide (CO₂) footprint data including CO₂ output quantities embodied in construction materials, per unit of energy used in building operations, and per residential occupant data for various modes of transportation. Such CO₂ footprint data also includes CO₂ sequestration potential per square foot of landscaping. This CO₂ data is compiled by modeling typical building scenarios using widely accepted methodologies for Life Cycle Assessment (such as the ISO Standard 14040-1997). Further, the CO₂ data includes regional consideration of the harvesting of materials or production of energy, transportation of materials or energy, and end-of-life scenarios.

The Major Components also have a significant impact on the building's carbon footprint embodied in materials. Accordingly, for such materials, the system specifically tracks the life cycle carbon embodied in the extraction, manufacture, transportation, construction, operation, and end of life of the materials.

Data sources 604 can also include default data including miscellaneous default inputs provided to the user throughout the software to enable the user to run very quick estimates without having to enter all of the details of a particular building. Default inputs can be based on a project location, codes and standards for the project location, other profile factors, or other information, and such default inputs can be regularly updated to reflect market conditions. Further, the default inputs can be modified by the user. Data sources 604 further include bundles data store 126 configured to store data representing bundles or groups of impact factors from impact factors 120, which are organized to model a multi-impact building decision. Additionally, data sources 604 can include impact factors 120 and baselines 124, as well as error margins, such as margins of error 122 depicted in FIG. 1.

User input 710 includes a building profile, which is basic data about the user's particular building project, such as site area, building square footage, number of stories, whether the building is an existing building or a potential new construction project, building location, and construction cost market multiplier. User input 710 further includes utility data, including cost rates for energy, green energy, water, and wastewater (grey water). For an existing building, such utility data can include actual utility bill summaries. Default utility rates are provided, with an attempt to match the user's input location as closely as possible to available data in the energy and water databases.

User inputs 710 further include structure types, such as residential, commercial, retail, or industrial. Further, the user inputs 710 can include material data, financial data, green or environmental strategy data, and other data. In general, the calculations and inputs in a Defining Spaces portion of the user input interface refer to a database of default assumptions about space use (General Space Modeling), including, for example, assumptions about the number of occupants per square foot for each space type, the number of recommended parking spaces per occupant, the number of plumbing fixtures per occupant for each space type, the cost per square foot for each space type, and the like. In some embodiments, the user can adjust these assumptions if desired.

Space and material modeling 712 is configured to assemble the project by adding individual spaces and for each space, defining the space type, square footage, number of identical spaces, revenue (rent), rent premium for green features, any fees in addition to utilities, and a breakdown of who pays ongoing costs (e.g., management or tenants). In addition, the user inputs the type of material used for the building structure. Default values are automatically provided based on a typical construction. For an existing building, the default values are provided based on when the building was constructed.

In the illustrated embodiment, space and material modeling 712 represents an initial step in the modeling process, which takes the user inputs, such as profile data, spaces data, and material data (and/or some combination of such user inputs and default data) and applies some calculations based on data in data sources 604 to estimate useful quantities. Such useful quantities include building footprint data, site open space, roof area, façade area, quantities of materials for the structure, façade, and roof, and other data. Space and material modeling 712 also takes the individual space areas and estimates a number of occupants based on the space type, which number can be used to determine such things as water usage, expected rents, and the like. To the extent that the user input is incomplete, space and material modeling 712 uses defaults data to complete the building profile or selects appropriate data from data sources 604 based on building codes associated with a location of a particular building to complete the building profile.

Data from space and material modeling 712 is provided to modeling tool 704. Modeling tool 704 retrieves a correct baseline factor from baselines 124 and one or more impact factors from impact factors 120 based on the user input to model an environmental impact of the building.

Modeling tool 704 includes a financial modeling tool, which uses traditional real estate financing calculations to estimate construction costs, cash flow, expenses, and income. Construction costs are calculated by taking the results from space and material modeling 712 and user input and applying costs from the construction cost data of data sources 604. Detailed construction cost estimates are assembled from construction cost line items selected from a line item database to match the particular conditions of a user's project. Total construction cost is adjusted with a regional cost multiplier.

Miscellaneous development costs, including estimated fees for legal services and architectural design services are added to the land purchase cost or existing building cost and the detailed construction cost estimate. The resulting information is processed using a typical load scenario to estimate a mortgage payment. Green strategies can be applied using selected impact factors of the impact factors 120 to adjust the costs.

On-going operating expenses are balanced against on-going income from the user input, space information, and revenue data to produce an estimate of cash flow for the building. The estimate is translated using other standard financial calculations to produce an estimated value for the investment. One or more of the impact factors 120 can be applied, if green (energy efficiency) strategies are employed, to adjust the operating expenses to reflect such strategies.

Expenses represent on-going operational costs, including repairs, utilities, insurance, management, and any utilities paid for by management. Utilities are calculated by taking the results of the energy and water modeling and by multiplying the energy and water results by the utility rates for the location associated with the building. The utility costs are reported for individual spaces so that payment responsibility can be tracked between management and tenants. Baseline utility costs are calculated using baseline energy and water modeling results from baselines 124 and non-green energy rates. The total project and utility costs are then entered into the overall operational costs. If green strategies are employed, such baseline utility costs can be adjusted using impact factors 120 to reflect the green strategies.

Income is calculated by taking the user input revenue per space plus any specified premiums (for green strategies using one or more impact factors 120) and multiplying these by square footage. Baseline income is calculated by excluding premiums. The results are then entered into the overall project and baseline financial models.

Energy modeling applies the space, number of individuals, usage type, and other information to estimate energy usage for the building, which energy usage is divided into the individual spaces. Water modeling determines water use and conservation potential for a variety of components. For building plumbing fixtures, number of occupants for each space is multiplied by typical usage and fixture flush and flow rates available from the water data in data sources 604. If a green strategy for plumbing is selected, then reduced flush and flow rates are applied using one or more of impact factors 120. For landscape irrigation, landscape area is multiplied by typical water use per square foot, which water use is reduced using one or more of impact factors 120 if a green landscape strategy is used.

Landscape irrigation quantities can also take into account whether the user has selected a rainwater collection or grey water reuse as green strategies. A general calculation estimates how much water would be physically available for collection (based on roof area for rainwater, or based on building plumbing usage for grey water). The user chooses how many green strategies to use. Each green strategy potentially implicates one or more of impact factors 120 to adjust the quantities.

Public health modeling estimates public health impacts based on user input, number of tenants, and the like based on pollutants resulting from the construction and operation of the building and corresponding public and occupant health impacts, which can be derived from Life-Cycle Assessment modeling, other pollutant and health impact estimating techniques, and academic studies.

CO₂ modeling estimates carbon footprint data based on quantities embodied in construction materials, per unit of energy used in building operations, and per residential occupant data for various modes of transportation, as well as per square foot of landscaping. Such data can be adjusted using one or more of the impact factors 120 based on selected green strategies.

Bundles data store 126 includes combinations of impact factors and their corresponding impacts when implemented together. The bundle system simplifies and improves impact calculations related to multi-impact decisions, allowing system 700 to readily calculate the impact of a particular decision, even when such a decision impacts multiple, unrelated categories that cannot readily be combined.

Green ratings modeling can apply any number of algorithms to determine an environmental usage rating, such as Leadership in Energy and Environmental Design (LEED) certifications and/or other ratings or certifications.

Output components 708 include an instant feedback tool 716 to generate for the building a plurality of outputs, including project costs, carbon footprint, net cash flow, green rating, property values, cost per pound of carbon dioxide that is diverted using particular green strategies, and cost per kilowatt hour saved. Such instant feedback can be provided to the user through a user interface or through a report.

Output components 708 further include a recommended strategies tool 718, which analyzes the existing building data and available green strategies, incentives, and other data to make recommendations regarding possible green strategies that can improve the on-going costs without adding so much to the up-front construction costs that there would be no return on investment for the owner. Such recommended strategies can take into account the cost per pound of carbon dioxide diverted and the cost per kilowatt hour saved to identify strategies that provide a return on investment (ROI) that is above a pre-determined threshold. In one example, the pre-determined threshold can be a desired period of time over which the initial construction-related investment is expected to be paid off through energy savings. In an embodiment, the desired ROI can be configured by a user through user inputs 710.

Output components 708 also include a reports module 720, which generates output reports in a variety of formats and for a variety of purposes. Such reports can include appraisal reports, economics analysis reports, LEED checklists, Incentives reports, preliminary design checklists, green tenant lease requirement reports, green product guides, residential health and well-being reports, and local impact reports. Further, reports module 720 can include custom reports, which can be configured by the user to produce a desired output.

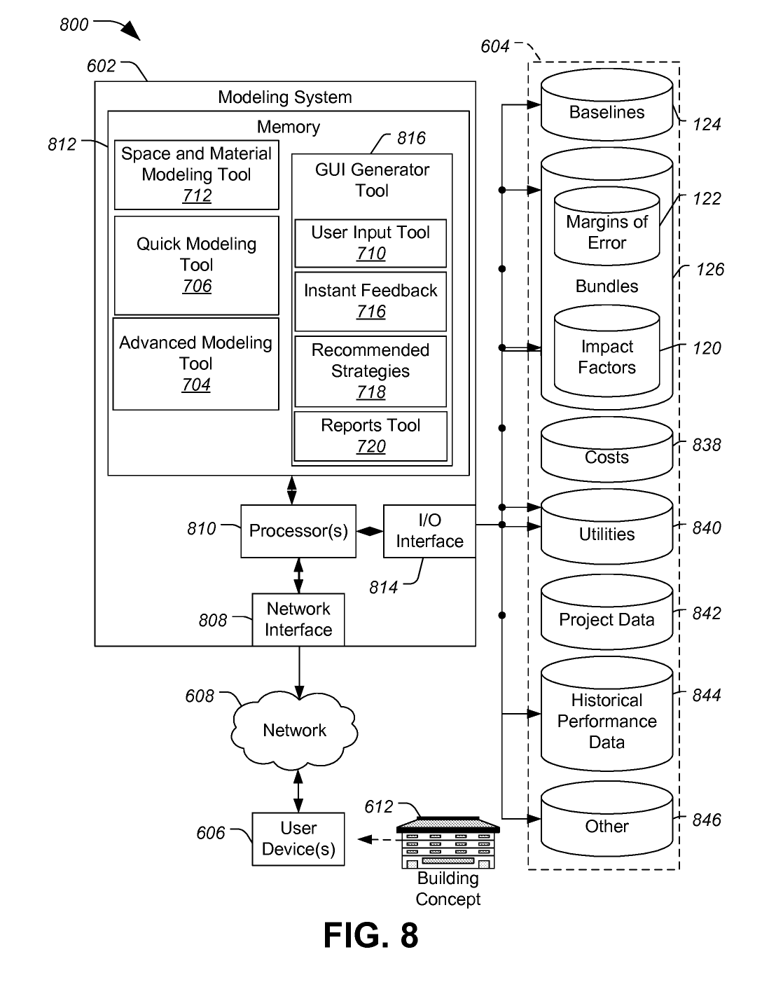

It should be understood that the tools and data flow depicted in FIG. 7 can be distributed across multiple computing systems, such as computer servers in a network environment. Alternatively, the tools and data flow occurs within a single computing system, such as computing system 800 depicted in FIG. 8.

FIG. 8 is a block diagram of an expanded view of a system 800 including the modeling system 602 of FIG. 6 and including an expanded view of the data sources 604. Modeling system 602 includes a network interface 808 communicatively coupled to network 608 and connected to one or more processor 810. One or more processors 810 are coupled to data sources 604 though an input/output (I/O) interface 814 and to a memory 812. In some instances, I/O interface 814 may be omitted and data sources 604 may be connected to modeling system 602 through network 608. In other instances, memory 812 includes data sources 604.

Memory 812 includes space and material modeling tool 712, modeling tool 704 and graphical user interface generator 816. GUI generator 816 includes user input tool 710, instant feedback tool 716, recommended strategies tool 718, and reports tool 720.

In the illustrated embodiment, data sources 604 include baselines 124, margins of error 122, and impact factors 120, which store data generated through the iterative modeling process described above with respect to FIGS. 1-5. Further, data sources 604 include a costs database 838, a utilities database 840, and other databases 846 as described above with respect to data sources 604 in FIG. 7. Further, data sources 604 include a project database 842, which stores data related to one or more projects created by a user. In one instance, each user has his/her own project database 842. In another instance, the project database 842 stores projects associated with multiple unrelated users, and access to the stored data can be controlled through well-known authentication, authorization, and account management techniques so that each user only has access to his/her own project data.

Additionally, data sources 604 include historical performance database 844, which stores energy usage and cost data associated with actual buildings. As previously discussed, such performance data can be used to adjust cost and performance calculations. Further, data sources 604 include other databases 846 and bundles data store 126.

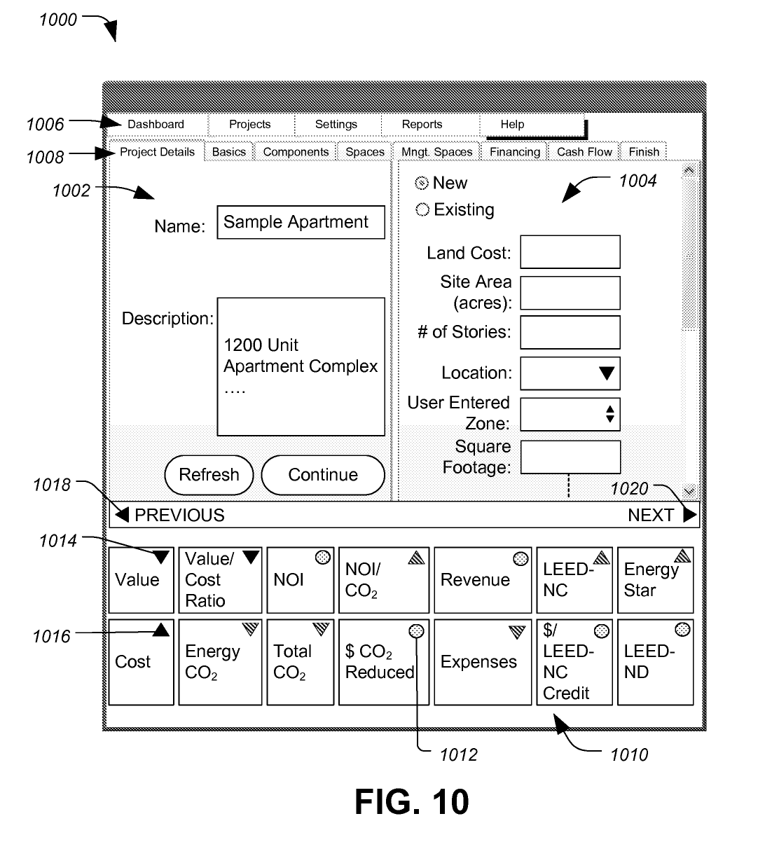

In operation, processor 810 executes GUI generator 816 to produce a user interface, such as the user interface depicted in FIG. 10, to provide a series of inputs (user inputs tool 710) through which a user can input information relating to a building, such as square footage, geographic region, and usage type information. It should be understood that the user interface includes a plurality of inputs through which a user can provide a complete specification of a building. However, upon receipt of the square footage, geographic region, and usage type information, processor 810 can utilize default inputs to complete the model. Further, processor 810 executes instant feedback tool 716, recommended strategies tool 718, and reports tool 720 to provide results data to the user through the user interface.

As the user adds further information to the project, processor 810 applies modeling tool 704 to calculate revised environmental and cost impacts of the building based on the additional information. The resulting economic and cost impact information is processed using GUI generator tool 816 to update the user interface with the resulting economic and cost impact data, which may be presented along side of the previously generated environmental and cost impact data to graphically represent the deviation from the baseline. In some instances, the associated margin of error information can be included with the various economic and cost impact data. In such an instance, the margin of error is graphically rendered or presented as supplemental information along with the presented data.

In an example, modeling system 602 receives user input related to a building concept 612, retrieves data from data sources 604 and generates a report or dashboard of indicators quantifying the environmental impact, cost impact, and other impacts of the modeled building. Modeling system 602 receives further inputs from the user. In an instance, the further inputs include a selection related to a bundle within bundles data store 126. Modeling system 602 applies the bundle to calculate results based on the user selection, which results may be non-additive, meaning the results do not equate to a sum of individual impacts of a particular decision. Modeling system 602 provides the results to the user device 606 within a graphical user interface, which may be rendered within an Internet browser application.

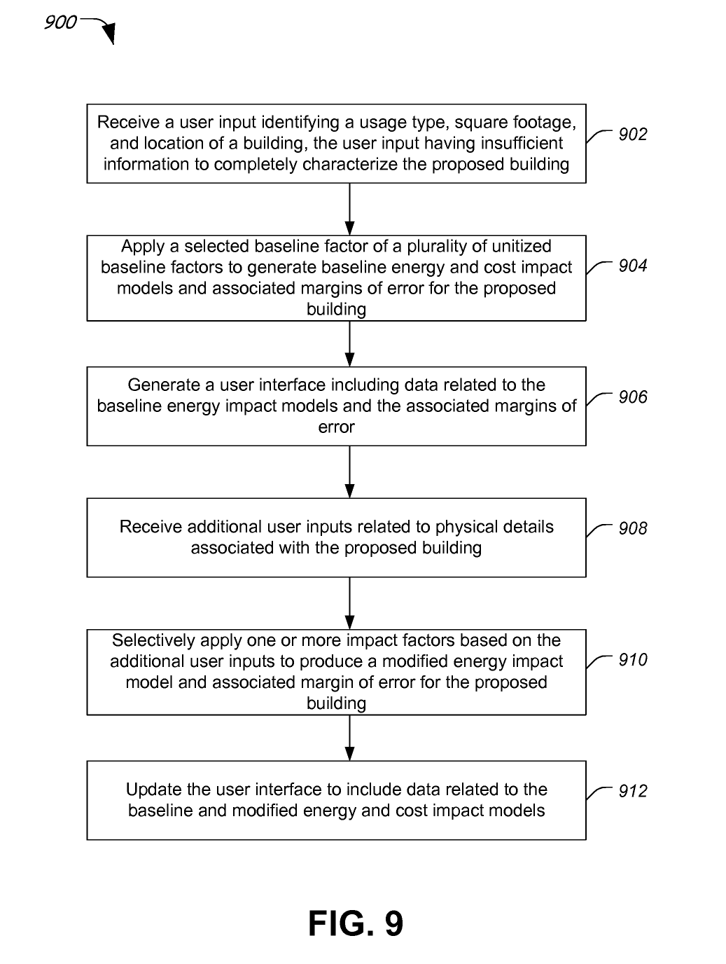

It should be appreciated that the systems 600, 700, and 800, depicted in FIGS. 6, 7, and 8, respectively, are configured to generate environmental and cost impact data based on a complete building profile and/or partial building information. In some instances, the energy usage can be modeled first and costs can be applied to the energy usage model to complete the cost impact data. An example of a method of producing such environmental impact models with such data is described below with respect to FIG. 9.

FIG. 9 is a flow diagram of a second embodiment of a method 900 of modeling energy usage, construction costs, and operational costs for a physical structure. At 902, a user input is received that identifies a usage type, square footage, and location of a building, where the user input has insufficient information to completely characterize the building. Advancing to 904, a selected baseline factor of a plurality of unitized baseline factors is applied to generate a baseline energy impact model and associated margin of error for the building. Moving to 906, a user interface is generated that includes data related to the baseline energy model and the associated margin of error.

Continuing to 908, additional user inputs are received that are related to physical details associated with the building. Proceeding to 910, one or more impact factors are selectively applied based on the additional user inputs to produce modified energy impact models and associated margins of error for the building. Moving to 912, the user interface is updated to include data related to the baseline and modified energy models.

In an embodiment, the above-described method 900 may be performed iteratively. In particular, blocks 908-912 may be performed any number of times as the user continues to update the building project details. Further, the user interface can include a plurality of inputs accessible by a user to define a project profile and associated building details for the purpose of modeling energy impacts. An example of one possible user interface out of many possible user interfaces is disclosed below with respect to FIG. 10. Applicant notes that, in an embodiment, the user interface may be rendered within an Internet browser application using XML pages, scripts, Hypertext Markup Language (HTML) files, and other browser-compatible instructions provided by the modeling system 602. Alternatively, such pages and associated data can be served by a computer server, such as an Active Server Pages (ASP)-enabled computing device.

FIG. 10 is a diagram of an embodiment of a user interface 1000 produced by the modeling systems of FIGS. 6-8 to receive user input related to a physical structure and to provide reports related to the modeled energy usage, construction costs, and operational costs for the physical structure. User interface 1000 can utilize any number of input elements, such as text boxes, pull-down menus, check boxes, radio buttons, clickable links, submit and reset buttons, and the like for receiving user input.

In the illustrated embodiment, user interface 1000 includes a project details panel 1002 and a basics panel 1004 of a building project. Additionally, user interface 1000 includes menu items 1006 for accessing various functions of the modeling system 602 and includes tabs or panel indication elements 1008 to identify which input page is currently selected with which the user interacts to supply details relating to the project.

Environmental and cost impact results are represented in a results panel 1010, which represents various factors, such as value, cost, value/cost ratio, energy CO₂, net operating income (NOI), total CO₂, NOI/CO₂, cost ($) per unit reduction in CO₂, revenue, expenses, the LEED® for new construction (LEED-NC), cost for each LEED-NC credit, Energy Star analysis, and the LEED® for neighborhood development (LEED-ND), and optionally other results. Within the results panel, change indicators, such as indicators 1012, 1014, and 1016 can be used to indicate how a current building profile compares to a baseline profile. As the user provides more inputs relating to the building, the environmental and cost impact results are updated to reflect the changes, and the indicator is updated to reflect the relative change.

In the illustrated embodiment, a dark indicator, such as indicators 1014 and 1016, represents a greater change than a partially-filled indicator 1012. Additionally, the point of the triangles of indicators 1014 and 1016 indicate whether the change represents an increase or decrease relative to the baseline model. Indicator 1012 has a circular shape indicating that the change is neutral relative to the baseline. In an alternative embodiment, a color coding scheme indicates the relative changes, either by changing the indicator color. Though in the illustrated embodiment the indicator is a shape within a larger box, in an alternative embodiment, the color or order of the larger boxes or a lettering size or color may be adjusted to indicate the relative change.

Further, in the illustrated embodiment, panel identification elements 1008 reflect the selected page. By clicking previous element 1018 or next element 1020 respectively, the user can navigate between the input panels. In one instance, the user interface is a continuous page that extends vertically and horizontally beyond the viewing window, and horizontal navigation through user interface 1000 is managed using previous element 1018 and next element 1020 to move horizontally through the possible input panels without having to reload the page.

In operation, a user can interact with user interface 1000 to enter basic profile information using project details panel 1002 and basics panel 1004, which allows the modeling system 602 to produce the environmental and cost impact data depicted in results panel 1010. The user can add additional details through the basics panel and through the other panels, including a components panel, a primary/secondary space panel, a management spaces panel, a financing panel, a cash flow panel, and a finish panel. Further, each of the blocks within the results panel 1010 can be accessed by the user to access the specific modeling information.

Further, the user can access a dashboard, other projects, settings, and reports using menu items 1006. Each of the other elements provides access by a user to underlying modeling details, report details, and the like. For example, the reports menu can be accessed by the user to access one or more pre-configured reports.

Based on information provided by the user through the fields presented within basics panel 1004 of user interface 1000, the modeling system selects a baseline factor and multiplies it by the square footage to determine a baseline energy usage model. Subsequently, the user can provide building details through other panels, including selecting various energy efficiency strategies, and one or more impact factors are selected and multiplied by the square footage to produce an adjusted energy usage model. Changes in energy efficiency, value, costs, and other parameters relative to the baseline energy usage model can be reflected as illustrated by indicators 1012, 1014, and 1016.

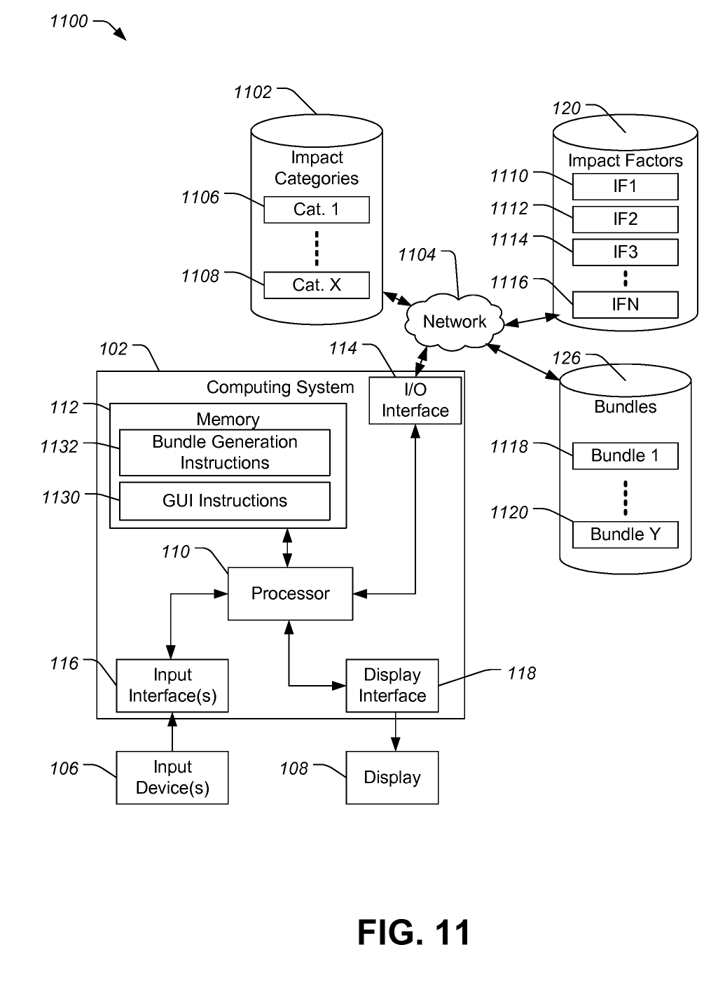

FIG. 11 is a block diagram of a system 1100 including the computing system 102 of FIG. 1 having further process-executable instructions for creating bundles representing multi-impact factors. In one embodiment, system 1100 is accessible only to the master administrator or operator of the software program. Computing system 102 includes all of the elements depicted and described with respect to FIG. 1. Additionally, computing system 102 includes graphical user interface (GUI) instructions 1130 and bundle generation instructions 1132 stored in memory 112 and executable by processor 110.

System 1100 further includes multiple data sources, including impact categories 1102, impact factors 120, and bundles data source 126, which are connected to computing system 102 through a network 1104. Network 1104 can be a local area network, a wide area network (such as the Internet), or any other type of communications network suitable for data communications.

Impact categories 1102 store information related to specific impact categories, such as an energy impact category, a cost impact category, a water usage category, and other categories. Impact categories 1102 include category 1 (Cat. 1) 1106 and any number of categories up to and including category X (Cat. X) 1108. Impact categories 1102 store information related to the impact of any particular building-related decision on the particular category. For example, the selection of one type of insulation for a particular building design has a corresponding impact in the energy impact category.

Impact factors 120 is a data source that includes any number of impact factors 1110, 1112, 1114, and 1116. Bundles data source 126 stores bundled groups of impact factors and categories to represent a multi-impact action. Bundles data source 126 can include any number of bundles, such as bundle 1118 and bundle 1120. Computing system 102 can be used to create bundles, such as bundle 1118 and bundle 1120, by grouping multiple existing impact factors 120 and information from impact categories 1102 to form new bundles. While impact categories 1102, impact factors 120, and bundles data store 126 are depicted as separate databases, categories 1102, factors 120, and bundles 126 may be stored together within a single data source or database. Alternatively, a fourth database (not shown) may store association or relationship data that defines relationships between impact categories 1102, impact factors 120, and bundles 126, making it possible for system 102 to retrieve relevant data based on the stored relationship data.

During operation, processor 110 executes GUI instructions 1130, causing processor 110 to generate a user interface that is accessible by the master administrator to generate a bundle 126. Processor 110 provides a user interface to allow the user to create one or more impact factors of impact factors 120. The Impact Factor creation interface includes a menu of model fields (such as “Total Construction Cost” or “Energy Baseline Factor for Office Building in ASHRAE climate zone 2d”). It also includes a menu of math functions to apply a modifier and variable to the selected field (such as “add $1.50 per variable Y” or “multiply by 0.5%”), and yet another menu of variable fields. The administrator builds as many impact factors as are relevant to the particular bundle. In response to an administrator selection, processor 110 executes bundle generation instructions 1132, causing processor 110 to bundle the impact factors created by the administrator. Further, processor 110 prompts the administrator to name the group. Upon receipt of a group name, processor 110 stores the newly created bundle in bundles data store 126. The bundles data store 126 represents a plurality of short cuts that allow the administrator to make an adjustment that has multiple impacts, without having to configure each individual change.

In another embodiment, regular users (not just the master administrator) may be provided with access to such a bundle generator, to enable them to create their own customized impact factors and bundles available only to them. Further, the system 1100 may be designed to allow users, operator/administrator users, an administrative user associated with a large company having access to the system, regular users, or any combination thereof, to share and trade created bundles with one another.

In some instances, the selected impact factors 120 may be non-additive. In other words, each efficiency factor includes a normalized percentage change in an estimated building parameter attributable to a particular design choice associated with a proposed building. Non-additive impact factors are impact factors that produce results that do not readily combine or aggregate. More particularly, such non-additive impact factors produce a result that is not equal to a sum of the individual normalized percentage changes. Instead, such efficiencies may be realized across multiple categories or may produce an effective efficiency factor that is greater than or less than the sum of the individual impact factors within the group. In such instances, the non-additive groups may be determined through iterative modeling using different modeling tools, such as modeling tools 105 in FIG. 1. Thus, in this example, the bundles enhance accuracy of the model while reducing data entry complexity by providing a short cut through which the user can select a multi-impact option through a single selection.

Assuming the bundles have already been created and stored in bundles data store 126, when the user selects a particular action or item that corresponds to an bundle, such as bundle 1118, computing system 102 applies the bundle 1118 to calculate the impacts across multiple categories to map out the multi-faceted nature of the impacts of the selected action.

In an example, upgrading the thermal insulation of a building reduces energy usage, but also costs money to install. An “upgrade thermal insulation” bundle stored in bundles data store 126 bundles an energy efficiency factor and a cost impact factor from impact factors 120 together. Computing system 102 applies the energy efficiency factor to adjust an energy usage calculation (quantified in kilowatt-hours per year or some other measure of energy usage) and applies the cost impact factor to adjust a construction cost calculation (quantified in dollars).

In some instances, a user accesses a user interface using input device 106 to select multiple bundles from bundles data store 126. In this instance, computing system 102 provides a menu or other selectable element within a graphical user interface (GUI) provided to display 108. The user interacts with the GUI using one or more input devices 106 to select multiple bundles from the menu. In some instances, in response to the selections, computing system 102 applies the selected bundles and adds the results in each respective category to adjust the various outputs.

System 1100 works even where there are several different impact categories 1106 and 1108, which cannot be easily ranked against one another. In such a case, the results in the various impact categories can be presented side-by-side, with further analysis left up to a human operator. For example, in a building design exercise, enabling a low-carbon fuel source for heating water could reduce carbon dioxide emissions, but could cost more money than gas heating. Computing system 102 applies the various impact factors 120 to produce the results and presents the results in a carbon dioxide emissions impact category of the output report and in an operational cost impact category of the output report. In the absence of any further methods for quantifiably normalizing the value of CO₂ reduction relative to cost, a human operator would decide whether the CO₂ reduction is worth the price.

In other cases, the results from various impact categories can be easily normalized. For example, in a building design exercise where a selected bundle 1118 provides energy savings and increased construction cost, computing system 102 subtracts the energy savings from total operating costs, and translates them, along with income, into an estimated long term value (or Net Present Value) for the building as a real estate investment. In an example, computing system 102 compares the estimated long term value against the initial increased construction costs (initial investment) to determine the impact of the decision.

In some instances, impacts of a decision result from a direct relationship with impact categories, which are themselves directly impacted by impact factors. Such impacts need not be separately represented by an efficiency factor 120. Instead, such impacts can be modeled by an algorithm executed by computing system 102, which reports the results alongside other impact categories.

For example, in a building design exercise, computing system 102 receives a selection corresponding to an increase in thermal insulation, which indirectly reduces carbon emissions by lowering energy usage. The carbon emissions impact is not modeled by an efficiency factor, but is modeled by an algorithm defining a direct relationship between energy use and carbon emissions. The energy of impact factors 120 for such a bundle, such as bundle 1120, would include an energy usage efficiency factor that represents reduced energy usage, and the corresponding reduction in carbon emissions would be calculated from the reduced energy usage.

In some instances, the costs/impacts in one area could be offset by savings/impacts in another. For impact factors 120 that are related to one another in a non-additive or non-linear way, bundle 1118 and bundle 1120 can include a consolidated efficiency factor, which represents the performance of several impact factors in the same category when implemented together. For example, in a building design exercise, where improving insulation has an energy efficiency factor of −2.1% and improving the mechanical equipment has an efficiency factor of −3.7%, the two strategies in combination produces an effective efficiency factor of approximately −5.3%, which is less than the sum of the two impact factors (−2.1+−3.7=−5.8). In such a case, the bundle called “Upgrade Thermal Insulation+Mechanical Equipment” would utilize a consolidated energy efficiency factor of 5.3%. Such consolidated efficiency factors allow modeling systems 602 and 700 to provide a more accurate output than if the results from applying the two impact factors independently were simply added together.

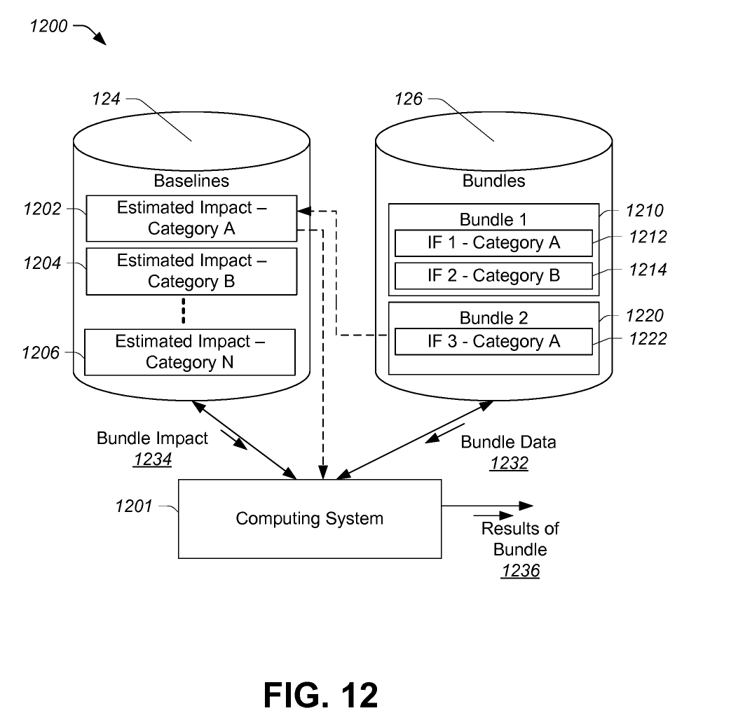

FIG. 12 is a simplified block diagram of a second embodiment of a system 1200 for creating customized impact factors. System 1200 includes computing system 1201 coupled to baselines 124 and bundles data store 126. Computing system 1201 can include some or all of the elements of computing system 102 in FIG. 1, computing system 602 in FIGS. 6 and 8, and system 700 in FIG. 7. Baselines 124 store baseline data for multiple impact categories, including baselines for estimated impact categories 1202, 1204, and 1206. Bundles data store 126 includes bundle 1210 and bundle 1220. Bundle 1210 includes an efficiency factor 1212 associated with estimated impact category 1202 and an efficiency factor 1214 associated with estimated impact category 1204. Bundle 1220 includes an efficiency factor 1222 associated with estimated impact category 1202.

In an example, computing system 1201 creates a baseline including estimated impact category 1202 using unitized values for impact categories, such as impact category A. During operation, computing system 1201 provides a user interface for receiving input from an operator. The operator selects one or more impact factors associated with particular impact categories and assigns them to a group, assigns a name to the group, and saves them to bundles data store 126 as a new bundle, such as bundle 1210. Bundle 1210 can include any number of impact factors corresponding to selection of a particular action or building choice. In this instance, bundle 1210 has two impact factors 1212 and 1214, which are associated with estimated impact categories 1202 and 1204, respectively.

Once the bundles data store 126 has been populated, computing system 1201 makes bundle 1210 and bundle 1220 available to users via the user interface. The user then selects from a menu of potential bundles (including bundle 1210 and bundle 1220) provided by computing system 1201. The user selects bundle 1210 and computing system 1201 receives bundle data 1232, and in response to the bundle data 1232, computing system 1201 retrieves bundle impact data 1234 (including baseline estimated impacts for the impact categories associated with bundle 1210). Computing system 1201 applies both impact factors 1212 and 1214 to the estimated impact categories 1202 and 1204, respectively. Computing system 1201 provides the results to the user, allowing the user to view the results while adjusting inputs or browsing to select another bundle. In one example, results of impact factors 1212 and 1214 are applied by adding the results in their respective categories. Computing system 102 provides results of the bundle 1236 to an output. In one instance, results of the bundle 1236 are updated within the GUI to present the updated results to the user almost instantly.

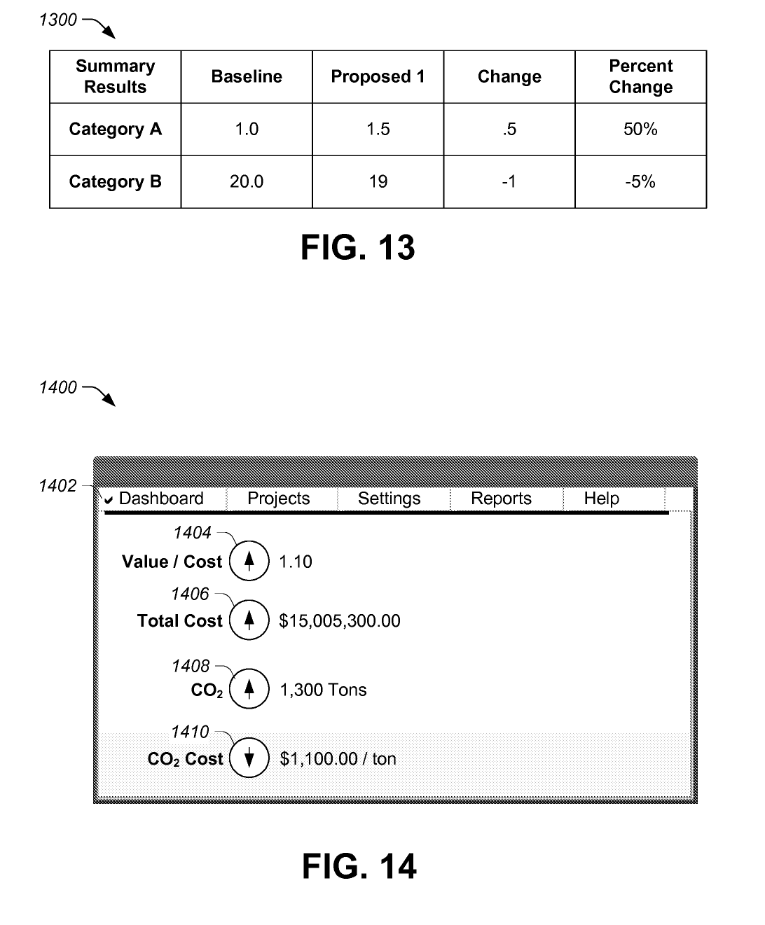

FIG. 13 is a diagram of an example of a table 1300 depicting an example of a static summary of quantified differences between baseline building models and proposed models. Table 1300 includes summary result data for a particular design option in a first category (Category A) and in a second category (Category B). Table 1300 can include any number of categories. Further, table 1300 relates a baseline design and a proposed design in each of the categories to determine a change amount and a percentage change. In this instance, the proposed model (Proposed 1) produces a change of 0.5 representing a change of fifty percent relative to the baseline in the first category. Further, the proposed model produces a change of minus one representing a five percent change relative to the baseline in the second category.

After the user is satisfied that the proposed model approximates desired performance through the instantly presented results, the user can view a more detailed, static summary of results, which enumerates performance in each category for the baseline and proposed models, including the quantified difference and percentage change. In this manner, the user accesses computing system 1201 to produce several theoretical models and to compare their summary results side-by-side to select the modeled design with a desired percentage improvement in each category.

FIG. 14 is a diagram of an embodiment of a user interface 1400 including a dashboard of indicators 1402 depicting a summary of quantified differences between a proposed model relative to a baseline model. In this embodiment, the dashboard of indicator 1402 is accessible by selecting the “Dashboard” tab.” In an alternative embodiment, the dashboard of indicators 1402 may be displayed along the bottom or along the side of a user interface including other information and/or user input elements.

Dashboard of indicators 1402 includes a value/cost indicator 1404, a total cost indicator 1406, a carbon dioxide indicator 1408, and a carbon dioxide cost indicator 1410. The indicators 1402, 1404, 1406, and 1408 include arrows, colors, shading, shapes, other parameters, or any combination thereof to indicate a relative change in the results due to the selection.

In an example, computing system 1201 presents dashboard of indicators 1402 to the user as a graphical and/or textual indicator providing substantially instant results during and throughout the modeling process. Each indicator 1404, 1406, 1408, and 1410 quantifies the performance of the proposed model in some labeled category relative to a baseline. The graphic may use color, shape, size, or other parameters to represent the change from the previous input. If the graphic indicates a change for a particular category, the graphic can include an arrow to indicate the direction of the change. If there is no change, the arrow (in this instance) can be omitted or can be presented horizontally. Further or alternatively, color may be used to indicate the desirability of the change. In one example, green represents a desirable change, red represents an undesirable change, and blue represents a neutral change or no change. The dashboard of indicators 1402 encapsulates results for the user in a visual display or dashboard that allows the user to continue manipulating the model while viewing the effects of such manipulations via the dashboard of indicators 1402.

In conjunction with the systems and methods and user interface depicted in FIGS. 1-14, a system is disclosed that is configured to generate baseline energy and cost impact models for a building based on incomplete information about the building using a unitized baseline that corresponds to input from the user. Further, the baseline models can be adjusted based on further details from the user by selectively applying one or more impact factors to produce adjusted models. In an example, such details from the user include selection of one or more bundles (groups of impact factors), which are applied to the baseline model to produce an adjusted model. In some embodiments, baseline models and adjusted models are depicted side-by-side to assist the user in evaluating the energy and cost impacts of various component, system, material, and strategic decisions. Further, indicators may be provided to draw the user's attention to the relative impact of various user selections on the bottom line, e.g. the return on investment for particular construction-related decisions.

Although the present invention has been described with reference to preferred embodiments, workers skilled in the art will recognize that changes may be made in form and detail without departing from the scope of the invention.

What is claimed is:

1. A system comprising:
a processor;
a memory comprising:
a first data store configured to store a plurality of impact factors, each of the plurality of impact factors comprising a normalized change in an estimated building parameter attributable to a particular design choice associated with a proposed building; and
a plurality of instructions that, when executed by the processor, cause the processor to receive a first user input selecting at least one of the plurality of impact factors, bundle the at least one of the plurality of impact factors into a group in response to receiving the user input, receive a second user input including a name to associate with the group, and store the group and the name in the memory; and
wherein at least one of the plurality of instructions, when executed by the processor, cause to processor to apply the group to adjust a selected baseline model of a building to produce a resulting model.

2. The system of claim 1, wherein:
the group includes multiple impact factors of the plurality of impact factors; and
results from application of the multiple impact factors are non-additive.

3. The system of claim 1, wherein the group comprises an effective efficiency factor.

4. The system of claim 1, wherein the memory stores a plurality of groups of impact factors and a respective plurality of associated names.

5. The system of claim 4, further comprising:
an interface coupled to the processor and adapted to couple to a network; and
wherein the processor receives the user input from the network.

6. The system of claim 5, wherein the memory further comprises a second data store configured to store a plurality of baselines, each of the plurality of baselines representing a baseline model of a building that satisfies building codes for a geographic region;
wherein the baseline model includes energy usage information; and
wherein the selected baseline model is selected from the plurality of baselines.

7. The system of claim 6, wherein the plurality of instructions further comprises at least one instruction that, when executed by the processor, causes the processor to:
generate a graphical user interface including a user-selectable element including at least one of the respective plurality of associated names;
provide the graphical user interface to a destination device through the network;
receive a user selection associated with the user-selectable element from the destination device;
retrieve one of the plurality of groups in response to receiving the user selection; and
apply each of the at least one of the plurality of impact factors of the one of the plurality of groups to adjust the selected baseline model of the building to produce the resulting model.

8. A computer-readable storage medium comprising a plurality of instructions that, when executed by a processor, cause the processor to:
receive a user input identifying a selection of a group of impact factors from a plurality of groups of impact factors, each group including multiple impact factors, each efficiency factor comprising a normalized change in an estimated building parameter attributable to a particular design choice associated with a proposed building;
adjust a baseline model of the proposed building based on the selection to produce an adjusted model of the proposed building; and
generate a user interface including data related to at least one of the baseline model and the adjusted model.

9. The computer-readable storage medium of claim 8, wherein at least one group of the plurality of groups of impact factors comprises an effective percentage change representing non-additive impact factors within the group of impact factors.

10. The computer-readable storage medium of claim 9, wherein the plurality of instructions, when executed by the processor, further cause the processor to apply the effective percentage change to generate the adjusted model, when the selection corresponds to the at least one group.

11. The computer-readable storage medium of claim 8, wherein the user interface includes a dashboard of indicators representing a difference between the adjusted model and the baseline model.

12. The computer-readable storage medium of claim 8, wherein the plurality of instructions, when executed by the processor, further cause the processor to transmit the user interface to a destination device through a network.

13. The computer-readable storage medium of claim 8, wherein the plurality of instructions, when executed by the processor, further cause the processor to:
receive a user selection identifying multiple impact factors of the plurality of impact factors;
bundle the multiple impact factors into a group;
receive a second user input to associate a name with the group; and
store the group and the name in a memory.

14. The computer-readable storage medium of claim 13, wherein the plurality of instructions, when executed by the processor, further cause the processor to associate an effective efficiency factor with the group.

15. A system comprising:
an interface adapted to couple to a network;
a memory comprising a plurality of groups of impact factors of a plurality of impact factors, each of the plurality of impact factors comprising a normalized change in an estimated building parameter attributable to a particular design choice associated with a proposed building; and
a processor coupled to the memory and to the interface, the processor configured to receive user input from the network and to selectively apply a group of the plurality of groups to a baseline model of a proposed building to produce an adjusted model in response to the user input, the processor configured to generate a user interface including data from the adjusted model and to send the user interface to a destination device through the network.

16. The system of claim 15, wherein the user interface includes a dashboard of indicators representing a relative difference between the baseline model and the adjusted model.

17. The system of claim 16, wherein the relative difference is less than a sum of differences of each of the impact factors within the group.

18. The system of claim 15, wherein the baseline model of the proposed building represents a selected one of a plurality of baselines, each of the plurality of baselines representing energy usage and cost parameters of a building that satisfies building codes for a geographic region;
wherein the baseline model includes energy usage information; and
wherein the baseline model is selected from the plurality of baselines.

19. The system of claim 15, wherein the user interface includes an estimation of energy usage associated with the baseline model and an adjusted estimation of energy usage associated with the adjusted model.

20. The system of claim 15, wherein the processor is configured to receive an input identifying multiple impact factors, bundle the multiple impact factors to form a group, receive a user input including a name to associate with the group, and store the name and the group in the memory within the plurality of groups.
